(19) United States
(12) Patent Application Publication
(10) Pub. No.: US 2011/0093157 A1
(43) Pub. Date: Apr. 21, 2011

(54) SYSTEM AND METHOD FOR SELECTING A MAINTENANCE OPERATION

(75) Inventors: Manoj Kumar Prabhakaran, Bangalore (IN); Dennis McAndrew, Waterford, PA (US); Dariusz Oracz, Warsaw (PL); Aneta Goska, Warsaw (PL); Pawel Hlozek, Warsaw (PL)

(73) Assignee: General Electric Company, a New York Corporation, Schenectady, NY (US)

(21) Appl. No.: 12/582,512

(22) Filed: Oct. 20, 2009

(51) Int. Cl. G01M 15/00; G06N 5/02; G06F 15/00

(52) U.S. Cl. 701/30; 706/52; 702/184

(57) ABSTRACT

There is provided a method of selecting a maintenance operation to be performed on a device. An exemplary method comprises determining a health parameter for the device, the health parameter being predictive of a probability of failure of the device based on archival data about a plurality of devices similar to the device. The exemplary method also comprises performing a first maintenance operation on the device if the health parameter indicates that the probability of failure of the device is below a threshold. The exemplary method additionally comprises performing a second maintenance operation on the device if the health parameter indicates that the probability of failure of the device exceeds the threshold.

### BACKGROUND

The invention relates generally to a system and method for selecting a maintenance operation to be performed on a device. The selection may be made based on an evaluation of some aspect of the device, such as engine health as determined by fluid condition, material usage rate or the like.

Locomotive engines require periodic maintenance to continue to function efficiently with high reliability. It is typical to perform a complete overhaul on locomotive engines after certain predetermined periods of usage, or time in service. For example, a complete engine overhaul may be performed after 26,000 Megawatt Hours (MWH). The performance of maintenance based on time in service may result in the expenditure of maintenance resources to repair an engine that is actually in good operating condition. On the other hand, an engine that is not operating correctly may break down before it reaches the time in service milestone for maintenance.

In an attempt to ensure the safe operation of locomotives in the railroad fleet, the United States government has mandated that active locomotives undergo inspections at maximum intervals of 92 days. As a result of this mandate and in order to minimize the downtime of active locomotives, the routine maintenance of these locomotives is typically scheduled to revolve around this 92-day inspection cycle. For example, the engine oil and filters are routinely drained or changed every 92 or 184 days. In addition, frequent oil specimens are collected approximately every 10-15 days. Oil specimens are typically sent to a laboratory for analysis. The resultant data from this analysis is entered into an operations database, wherein the operations database includes the results of previously analyzed specimens. A field service engineer then reviews and evaluates the oil parameter data to determine if the data exceeds established parameters. If any limits are exceeded, the field service engineer takes the prescribed action responsive to the limit(s) exceeded. For example, a computer that is analyzing the data may provide an indication when a particular parameter exceeds a threshold.

Unfortunately, however, the current approach toward identifying potential engine failure includes several undesirable limitations. There is therefore a need for a system and method of effectively diagnosing engine health or condition. Such a system and method may necessitate performing maintenance on locomotive engines in a cost-effective manner.

### SUMMARY

Briefly, in accordance with an exemplary embodiment of the present invention, a system and method of selecting a maintenance operation to be performed on a device are provided. An exemplary method comprises determining a health parameter for the device, the health parameter being predictive of a probability of failure of the device based on archival data about a plurality of devices similar to the device. The exemplary method also comprises performing a first maintenance operation on the device if the health parameter indicates that the probability of failure of the device is below a threshold. The exemplary method additionally comprises performing a second maintenance operation on the device if the health parameter indicates that the probability of failure of the device exceeds the threshold.

An exemplary embodiment of the present invention relates to a computer system that is adapted to select a maintenance operation to be performed on a device. The computer system comprises a processor and a tangible, machine-readable storage medium that stores machine-readable instructions for execution by the processor. The machine-readable instructions comprise code that, when executed by the processor, is adapted to cause the processor to determine a health parameter for the device. The health parameter may be predictive of a probability of failure of the device based on archival data about a plurality of devices similar to the device. The machine-readable instructions also comprise code that, when executed by the processor, is adapted to cause the processor to identify a first maintenance operation to be performed on the device if the health parameter indicates that the probability of failure of the device is below a threshold. The machine-readable instructions additionally comprise code that, when executed by the processor, is adapted to cause the processor to identify a second maintenance operation to be performed on the device if the health parameter indicates that the probability of failure of the device exceeds the threshold.

A tangible, machine-readable medium according to an exemplary embodiment of the present invention stores machine-readable instructions executable by a processor to select a maintenance operation to be performed on a device. The tangible-machine-readable medium comprises machine-readable instructions that, when executed by the processor, determine a health parameter for the device, the health parameter being predictive of a probability of failure of the device based on archival data about a plurality of devices similar to the device. The tangible-machine-readable medium also comprises machine-readable instructions that, when executed by the processor, identify a first maintenance operation to be performed on the device if the health parameter indicates that the probability of failure of the device is below a threshold. The tangible-machine-readable medium additionally comprises machine-readable instructions that, when executed by the processor, identify a second maintenance operation to be performed on the device if the health parameter indicates that the probability of failure of the device exceeds the threshold.

### DRAWINGS

These and other features, aspects, and advantages of the present invention will become better understood when the following detailed description is read with reference to the accompanying drawings in which like characters represent like parts throughout the drawings, wherein:

FIG. 1 is a graph useful in explaining the determination of an engine health parameter according to an exemplary embodiment of the present invention;

FIG. 2 is a graph showing the creation of a transfer function corresponding to an engine health parameter in accordance with an exemplary embodiment of the present invention;

FIG. 3 is a graph useful in explaining the use of an engine health parameter to determine a maintenance operation according to an exemplary embodiment of the present invention;

FIG. 4 is a block diagram showing the use of a plurality of transfer functions corresponding to engine health parameters to determine a maintenance operation according to an exemplary embodiment of the present invention;

FIG. 5 is a block diagram of a computer system that is adapted to determine a maintenance operation in accordance with an exemplary embodiment of the present invention;

FIG. 6 is a process flow diagram showing a method of determining a maintenance operation in accordance with an exemplary embodiment of the present invention; and

FIG. 7 is a block diagram of a tangible, machine-readable medium that stores code adapted to determine a maintenance operation according to an exemplary embodiment of the present invention.

### DETAILED DESCRIPTION

An exemplary embodiment of the present invention relates to a system and method of selecting a maintenance operation to be performed on a device such as a locomotive engine. The selection may be made based on a determination of engine health, as represented by one or more engine health parameters. Engine health parameters, which may measure a probability of an engine failure before a next service interval, may be determined based on various types of engine health data. As used herein, the term “engine health data” refers to oil parameter data, fault log data, parts usage data or any other type of data that may be correlated to potential engine failure. Examples of the determination of one or more engine health parameters based on engine health data are set forth herein.

Engines that are in good health may receive reduced maintenance compared to engines that are in poor health. For example, a locomotive that is scheduled to receive an oil change may be returned to service without the oil change if one or more engine health parameters indicate that an engine failure is unlikely to occur prior to a next scheduled maintenance period. In addition, a locomotive engine scheduled to receive a complete engine overhaul may receive a reduced maintenance operation or process comprising top deck maintenance instead of the complete overhaul if one or more engine health parameters indicate that a probability of failure prior to a next scheduled service is unlikely. Moreover, the reduced maintenance process may be chosen if the engine health parameter indicates that the probability of engine failure does not exceed a threshold value. As will be understood by one of ordinary skill in the art, top deck maintenance of a locomotive engine involves renewing components in the upper part of the engine and not in the lower portion of the engine such as the crankcase. Top deck maintenance is less costly and time consuming than a complete overhaul.

In one exemplary embodiment, engine health parameters may be determined by performing a regression analysis on an average value as well as a slope of an oil parameter change normalized to MWHs. In addition to oil parameter data, engine health parameters according to an exemplary embodiment of the present invention may take into account information such as fault log data, parts usage data or the like.

Engine health parameters may be generated in light of historical failure data about a large number of similar engines to identify an incipient engine failure even though individual oil parameters are within acceptable limits Moreover, the historical data may be evaluated to identify patterns of data for engines that subsequently failed, even though individual parametric data for those engines were within acceptable limits. Engine health parameters may be devised to indicate an increased likelihood of failure when these patterns are present. Thus, the use of engine health parameters in this manner allows corrective action to be performed on engines if one or more engine health parameters indicate an incipient engine failure, even though prior methods of identifying potential problems may indicate that all parameters of interest are within acceptable limits. An exemplary embodiment of the present invention is believed to provide opportunities to improve the cost and effectiveness of maintaining locomotive engines relative to the current practice, which is to evaluate oil quality parameters to determine if absolute limits are exceeded.

Exemplary embodiments of the present invention relate to a system and method for monitoring the operational health of an engine by analyzing engine fluid specimens and other data in light of historical failure data. It should be appreciated that, although specific examples are discussed herein with regard to analyzing exemplary characteristics of a locomotive engine, exemplary embodiments of the present invention may be applied to any type of data for which a correlation to potential failure may be determined. Moreover, engine health parameters may be determined based on an analysis of mechanical and/or electrical characteristics of the engine, among others. In addition, although specific examples are set forth herein that relate to locomotive engines, it is contemplated that exemplary embodiments of the present invention may also relate to other types of devices including, without limitation, automobile engines, ship engines, aircraft engines or the like.

As a general overview of data collection procedures with regards to the railroad industry, an oil specimen is typically collected from a locomotive engine at a predetermined frequency, such as every 7 to 10 days. Prior to sending the oil specimen out for analysis, oil specimen data is collected and logged, wherein the oil specimen data may include the locomotive from which the sample was collected, the date on which the sample was collected, the location from where the sample was collected and any other desired information regarding the oil sample. The specimen may then be sent out to an oil-testing laboratory for analysis to determine the chemical properties of the oil (e.g., such as alkalinity, oxidation, nitration), the physical properties of the oil (e.g., viscosity, presence of wear metals) and whether the oil was contaminated (e.g., fuel leak, water leak, wear metals). The results of the analytical tests are then entered into a central location database and evaluated against predetermined parameters (minimums or maximums).

The oil data thus collected may be analyzed as described herein to determine characteristics that are likely to occur prior to engine failure. Moreover, patterns leading to engine failure may be determined from historical data for a large number of engines, even though individual operating parameters are within acceptable limits For example, one or more engine fluid parameters may exhibit an increased rate of change in the time shortly before a failure occurs, even though the values of the individual parameters themselves remain within acceptable limits. These patterns may affect the determination of an engine health parameter by weighting the health parameter in favor of an increased likelihood of engine failure. As set forth below, one or more engine health parameters may be used to determine a maintenance operation to be performed on a particular engine. Moreover, engine health data may be used to select a maintenance operation that is cost-effective and yet reduces the likelihood that the engine will experience a failure before more extensive maintenance can be performed.

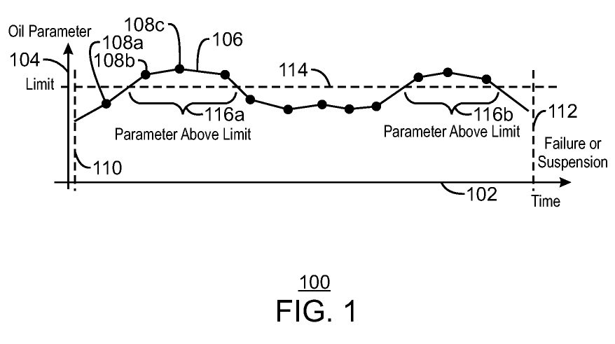

FIG. 1 is a graph useful in explaining the determination of an engine health parameter according to an exemplary embodiment of the present invention. The graph is generally referred to by the reference number 100. The graph 100 shows an x-axis 102, which corresponds to time. A y-axis 104 corresponds to a magnitude of an oil parameter of a locomotive engine. Examples of oil parameters that may be used to determine engine health include viscosity, alkalinity, acidity, concentrations of magnesium, sulfates, iron, lead, copper, oxidation, nitration or the like.

A trace 106 corresponds to measured values of the oil parameter. In particular, the trace 106 represents values of the oil parameter at periodic times 108a, 108b, 108c and so on, as indicated by the dots on the trace 106. A dashed vertical line 110 corresponds to an initial time and a dashed vertical line 112 corresponds to a terminal time such as failure of the locomotive because excessive time in service or suspension of the locomotive engine. A dashed horizontal line 114 represents a maximum limit of the oil parameter. Moreover, the limit is chosen such that values of the oil parameter that exceed the limit are likely to correspond to excessive wear leading to potential failure of the locomotive engine. As shown in FIG. 1, brackets 116a and 116b represent time periods for which the value of the oil parameter exceeds the value of the limit, as indicated by the dashed horizontal line 114.

According to an exemplary embodiment of the present invention, the area under portions of the trace 106 may be proportional to an engine health parameter such as crankshaft stress or the like. As can be seen in FIG. 1, the value of the oil parameter represented by the trace 106 is, at times, below the limit indicated by the dashed horizontal line 114. Also, the value of the oil parameter is, at times, above the limit If the oil parameter is sampled when its value is below the limit, known methods of evaluation would not identify a potential engine problem.

Rather than sampling a value of the oil parameter at a particular time, an exemplary embodiment of the present invention employs historical data about the engine to formulate an engine health parameter that is proportional to the area under the curve for time periods when the value of the oil parameter exceeds the limit When computed in this manner, the engine health parameter may be predictive of a potential engine failure based on the cumulative stress of periods when the oil parameter is above a desired operational limit

A range of values of the engine health parameter that may correspond to potential engine failure may be determined by examining archival engine health data gathered on a large number of similar engines. Such archival engine health data may relate to the servicing of the locomotive and may be collected and stored in a central database, wherein the information may include past service dates, scheduled service dates, oil analysis data, other descriptive data, other types of engine health data for each of the past service dates or the like. Stored data may also include processed data, such as regression analysis data and/or algorithm data. Engine health parameters computed according to this method may indicate that a potential failure is likely to occur before a next scheduled service even though the value of the oil parameter at any particular service point may be below the acceptable limit.

In addition to determining the area under the curve, time fulfillment, which may be defined as a percentage of time for which the value of the oil parameter exceeds the limit, may also be used to formulate an engine health parameter. Archival data regarding a large number of similar engines may be used to determine values of time fulfillment that correspond to a potential engine failure before a next service date.

In addition to oil parameter data, other types of engine health data may be used to determine an engine health parameter in accordance with an exemplary embodiment of the present invention. For example, fault log data may be used. Fault log data is data that is generated by one or more computerized diagnostic systems associated with an engine. Patterns of fault log data may be linked to one or more engine failure modes. Moreover, historical archives of fault log data may be analyzed to correlate fault log data to one or more engine failure modes. Observations of fault log conditions corresponding to increased risk of engine failure may be represented in an engine health parameter as an increased probability of a potential failure.

Similarly, parts usage data may also be correlated to engine failure modes. For example, the replacement of one or more parts over a period of time may correspond to a likely engine failure before a next service interval.

According to an exemplary embodiment of the present invention, several engine health parameters may be determined based on different types of engine health data. These engine health parameters may be combined to form an overall engine health parameter. Each of the constituent engine health parameters may represent one or more observations of archival engine health data about a large number of similar engines. Moreover, each engine health parameter may express the likelihood of a particular incipient engine failure mode, whether or not any specific underlying parameter exceeds an acceptable limit The likelihood of predicting a potential engine failure may increase as more engine health parameters are used to formulate the overall engine health parameter. The overall engine health parameter may represent an overall probability of engine failure before a next scheduled service.

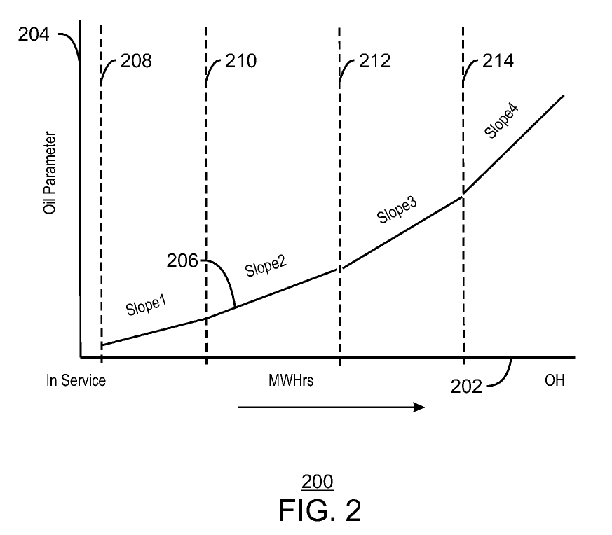

FIG. 2 is a graph showing the creation of a transfer function corresponding to an engine health parameter in accordance with an exemplary embodiment of the present invention. The graph is generally referred to by the reference number 200. As explained below, transfer functions may be developed to produce values for engine health parameters according to an exemplary embodiment of the present invention.

The graph 200 shows an x-axis 202, which corresponds to time in service in units of MWHs. A y-axis 204 corresponds to a magnitude of a measured parameter that corresponds to overall engine health, such as an oil parameter described above with reference to FIG. 1. A trace 206 shows the amplitude of the measured parameter over time. A first segment of the trace 206 extending between a first dashed vertical line 208 and a second dashed vertical line 210 has a slope of slope1. A second segment of the trace 206 extending between the second dashed vertical line 210 and a third dashed vertical line 212 has a slope of slope2. A third segment of the trace 206 extending between the third dashed vertical line 212 and a fourth dashed vertical line 214 has a slope of slope3. A fourth segment of the trace 206 extending beyond the fourth dashed vertical line 214 has a slope of slope4.

According to an exemplary embodiment of the present invention, the slopes of the various segments of the trace 206 are used to create a transfer function that produces a particular engine health parameter as output. As described herein, the slope of one or more engine health data elements may be indicative of a potential failure, even though underlying parameters remain within acceptable limits The transfer function may produce a health parameter that relates to a probability that an engine failure may occur prior to a next service interval. Moreover, the engine health parameter produced by the transfer function may predict a probability of failure based on analysis techniques discussed above, such as regression equations, area under the curve analysis, time fulfillment analysis, or the like. By applying these techniques to archival data about a large number of engines, the transfer function may be designed so that it produces a health parameter that predicts a likely failure even though one or more underlying data parameters does not exceed a preset limit when it is actually measured.

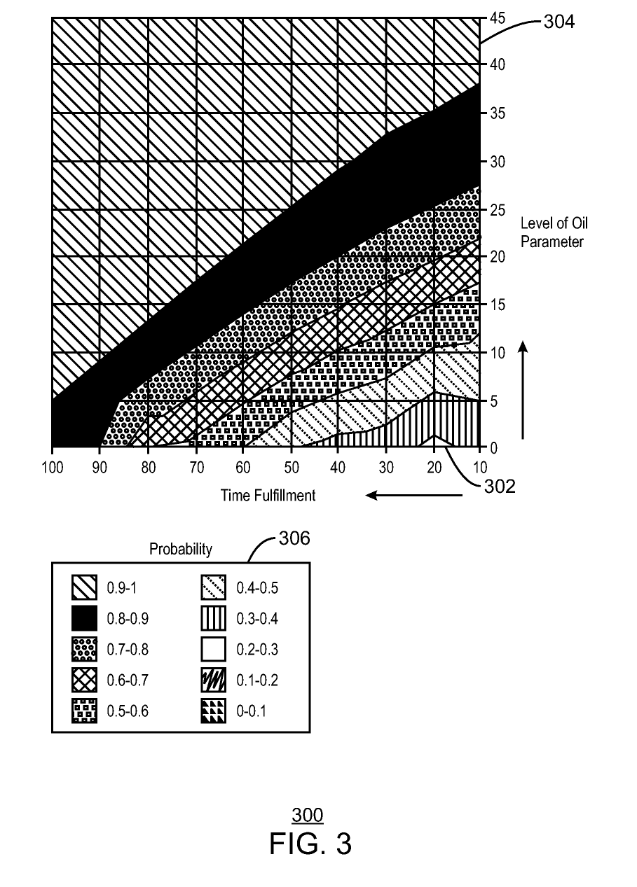

FIG. 3 is a graph useful in explaining the use of an engine health parameter to determine a maintenance operation according to an exemplary embodiment of the present invention. The graph is generally referred to by the reference number 300. The graph 300 shows an x-axis 302, which corresponds to time fulfillment for a particular oil parameter, expressed as a percentage. A y-axis 304 corresponds to a level of an oil parameter, such as engine oil insoluble soot. The graph 300 shows a probability of an engine failure, as indicated by a legend 306. Thus, the graph 300 shows an increased probability of engine failure as the time fulfillment grows, and as the level of the oil parameter grows.

As shown by the graph 300, growth in the value of the oil parameter (measured on the y-axis 304) has a greater impact on the probability of engine failure than does the time fulfillment, as shown by the x-axis 302. Thus, the area under the curve of the oil parameter, as discussed above with respect to FIG. 1, is a more reliable predictor of overall engine health than the time fulfillment for the same oil parameter. As set forth herein, probabilities of failure based on engine health parameters may be used to determine a maintenance operation for a particular engine.

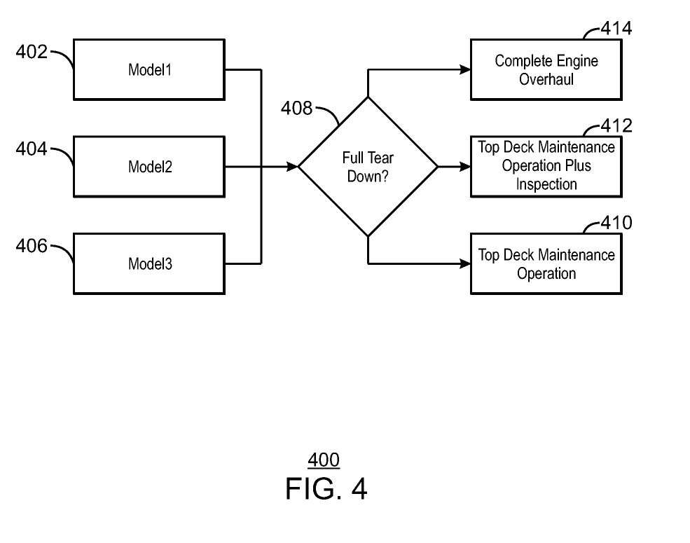

FIG. 4 is a block diagram showing the use of a plurality of transfer functions corresponding to engine health parameters to determine a maintenance operation according to an exemplary embodiment of the present invention. The diagram is generally referred to by the reference number 400. According to an exemplary embodiment of the present invention, the process shown in FIG. 4 may be performed at a time when the locomotive engine is scheduled for a significant maintenance operation, such as a complete engine overhaul. The analysis of engine health parameters described in relation to FIG. 4 may be used to determine that a less extensive, and therefore less costly, maintenance operation may be performed instead. In this manner, exemplary embodiments of the present invention may be employed to reduce maintenance costs.

Various engine health parameters may be measured prior to a scheduled maintenance. In an exemplary embodiment of the present invention, engine health parameters are derived as a function of parametric data obtained from various types of engine health data. In the graph 400, a first model 402 corresponds to a first transfer function that represents an engine health parameter determined as described above. An example of the first transfer function is:

Y=a₀*a₁+IRON*a₂+MAGNESIUM*a₃+s_SULFATE*a₄+IRON*s_SULFATE*a₅+MAGNESIUM*s_SULFATE*a₆+s_SULFATÊ2*a₇

In this example, the coefficients a₀ through a₇ are derived empirically based on historical or archival data, and may take into account historical data for a large number of similar engines. The output of the first transfer function may correspond to a probability that an engine failure will occur prior to a next service interval.

A second model 404 corresponds to a second transfer function that represents a different engine health parameter. An example of the second transfer function is:

Y=bₒ*b₁+IRON*b₂+MAGNESIUM*b₃+LEAD*b₄+COPPER*b₅+s_SULFATE*b₆+IRON*COPPER*−b₇+IRON*s_SULFATE*b₈+MAGNESIUM*s_SULFATE*b₉+LEAD*COPPER*b₁₀+s_SULFATÊ2*b₁₁

In this example, the coefficients b₀ through b₁₁ are derived empirically based on historical or archival data. The output of the second transfer function may correspond to a probability that an engine failure will occur prior to a next service interval.

A third model 406 corresponds to a third transfer function representative of still another engine health parameter. An example of the third transfer function is:

Y=cₒ*c₁+IRON*c₂+COPPER*c₃

In this example, the coefficients c₀ through c₃ are derived empirically based on historical or archival data. The output of the third transfer function may correspond to a probability that an engine failure will occur prior to a next service interval.

Exemplary embodiments of the present invention contemplate that any number of engine health parameters may be produced from transfer functions. As explained above, multiple engine health parameters may be combined to produce an overall engine health parameter. The overall engine health parameter may represent an overall probability of engine failure before a next scheduled service. In addition, indications of potential failure by multiple engine health parameters may be represented as in increased likelihood of failure when modeled as an overall engine health parameter.

At block 408, the output of the transfer functions produced at blocks 402, 404 and 406 are evaluated. If the engine health parameters produced by the transfer functions at blocks 402, 404 and 406 indicate that the engine is not likely to undergo a failure prior to a next scheduled service, a top deck maintenance operation may be performed rather than a complete engine overhaul, as shown at block 410.

The engine health parameters produced at blocks 402, 404 and 406 may indicate that a potential maintenance issue exists even though a failure prior to a next scheduled maintenance remains unlikely. In this case, a prescribed maintenance operation may include a top deck maintenance operation plus one or more additional inspections, as health parameter data may indicate, as shown at block 412. According to an exemplary embodiment of the present invention, a maintenance operation comprising a complete overhaul may only be performed when one or more engine health parameters indicates that a potential failure prior to a next service date is likely, as shown at block 414.

Exemplary embodiments of the present invention may provide numerous benefits and advantages. One such advantage may be to extend an oil drain interval based on an engine health parameter related to oil condition. Moreover, the engine health parameter may be used to predict whether an engine's oil can perform acceptably for another maintenance cycle. As described above, transfer functions may be used to generate an engine health parameter that gives a probability that the oil will perform acceptably until the next scheduled service based on archval oil parameter data, without regard to whether specific oil parameters exceed acceptable limits at any particular time.

In addition, exemplary embodiments of the invention may be employed to proactively intercept an engine with a potential problem before a failure occurs. Early failure detection allows necessary workscopes to be performed so that unscheduled failures are avoided. Engine health parameters that are useful for this purpose may include data based on oil parameters, material usage, fault logs or the like. As set forth above, analysis of this data may include the use of regression equations, area under the curve analysis or time fulfillment analysis, to name just a few examples. Using these analysis techniques, transfer functions may be developed that identify what part of an engine has a potential problem such as a water leak into oil, a bearing in bad condition, a power assembly that has the potential to fail, or the like.

Another benefit provided by an exemplary embodiment of the present invention may include the performance of limited workscopes if an engine health parameter indicates that a potential failure is unlikely. Moreover, a first maintenance operation such as a top deck process may be performed on a relatively healthy engine. A second maintenance operation such as a complete engine overhaul may be performed if the engine health parameter indicates a higher likelihood of failure. In this manner, maintenance costs are saved relative to a process of automatically performing a complete engine overhaul after a preset time in service. Engine health parameters that are useful for this purpose may include data based on oil parameters, material usage, fault logs or the like. Moreover, any of the previously-mentioned analysis techniques may be employed to generate an engine health parameter for this purpose.

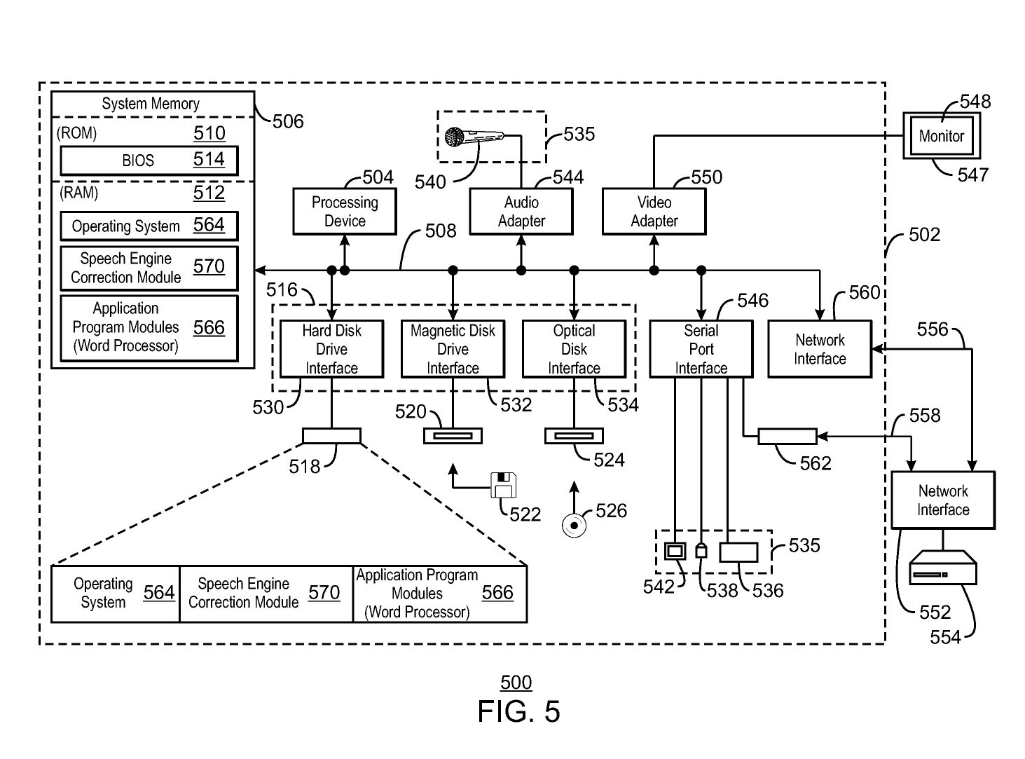

FIG. 5 is a block diagram of a computer system that is adapted to determine a maintenance operation to be performed in accordance with an exemplary embodiment of the present invention. The computer system is generally referred to by the reference number 500. Those of ordinary skill in the art will appreciate that an exemplary embodiment of the present invention may be embodied in the form of a computer- or controller-implemented process. Exemplary embodiments of the present invention may also be embodied in the form of computer program code containing instructions embodied in tangible media, such as floppy diskettes, CD-ROMs, hard drives, and/or any other computer-readable medium. Moreover, when the computer program code is loaded into and executed by a computer or controller such as the system 500, the computer or controller becomes an apparatus for practicing the invention. Exemplary embodiments of the present invention can also be embodied in the form of computer program code, for example, whether stored in a storage medium or loaded into and/or executed by a computer or controller. When implemented on a general-purpose microprocessor, the computer program code segments may configure the microprocessor to create specific logic circuits.

The computer system 500 comprises a processing device 504, a system memory 506, and a system bus 508, wherein the system bus 508 couples the system memory 506 to the processing device 504. The system memory 506 may include read only memory (ROM) 510 and random access memory (RAM) 512. A basic input/output system 514 (BIOS), containing basic routines that help to transfer information between elements within the general computer system 502, such as during start-up, is stored in ROM 510. The general computer system 502 may further include a storage device 516, such as a hard disk drive 518, a magnetic disk drive 520, e.g., to read from or write to a removable magnetic disk 522, and an optical disk drive 524, e.g., for reading a CD-ROM disk 526 or to read from or write to other optical media. The storage device 516 may be connected to the system bus 508 by a storage device interface, such as a hard disk drive interface 530, a magnetic disk drive interface 532 and an optical drive interface 534. The drives and their associated computer-readable media provide nonvolatile storage for the general computer system 502. Although the description of computer-readable media above refers to a hard disk, a removable magnetic disk and a CD-ROM disk, it should be appreciated that other types of media that are readable by a computer system and that are suitable to the desired end purpose may be used, such as magnetic cassettes, flash memory cards, digital video disks, Bernoulli cartridges, and the like. The tangible, computer-readable storage media shown in FIG. 5 may store machine-readable instructions that are adapted to cause a processor such as the processing device 504 to perform a method according to an exemplary embodiment of the present invention.

A user may enter commands and information into the general computer system 502 through a conventional input device 535, including a keyboard 536, a pointing device, such as a mouse 538 and a microphone 540, wherein the microphone 540 may be used to enter audio input, such as speech, into the general computer system 502. Additionally, a user may enter graphical information, such as a drawing or hand writing, into the general computer system 502 by drawing the graphical information on a writing tablet 542 using a stylus. Furthermore, the user may enter information into the general computer system 502 by first entering the information into a secondary device, such as a PDA, a Pocket PC and/or laptop computing device and then transferring the information into the general computer system 502. The general computer system 502 may also include additional input devices suitable to the desired end purpose, such as a joystick, game pad, satellite dish, scanner, or the like. The microphone 540 may be connected to the processing device 504 through an audio adapter 544 that is coupled to the system bus 508. Moreover, the other input devices are often connected to the processing device 504 through a serial port interface 546 that is coupled to the system bus 508, but may also be connected by other interfaces, such as a parallel port interface, a game port or a universal serial bus (USB).

A display device 547, such as a monitor or other type of display device 547, having a display screen 548, is also connected to the system bus 508 via an interface, such as a video adapter 550. In addition to the display screen 548, the general computer system 502 may also typically include other peripheral output devices, such as speakers and/or printers. The general computer system 502 may operate as a standalone system or in a networked environment using logical connections to one or more remote computer systems 552. The remote computer system 552 may be a server, a router, a peer device or other common network node, and may include any or all of the elements described relative to the general computer system 502, although only a remote memory storage device 554 has been illustrated in FIG. 1. The logical connections as shown in FIG. 1 include a local area network (LAN) 256 and a wide area network (WAN) 258. Such networking environments are commonplace in offices, enterprise-wide computer networks, intranets and the Internet.

When used in a LAN networking environment, the general computer system 502 is connected to the LAN 556 through a network interface 560. When used in a WAN networking environment, the general computer system 502 typically includes a modem 562 or other means for establishing communications over a WAN 558, such as the Internet. The modem 562, which may be internal or external, may be connected to the system bus 508 via the serial port interface 546. In a networked environment, program modules depicted relative to the general computer system 502, or portions thereof, may be stored in the remote memory storage device 554. It should be appreciated that the network connections shown are exemplary and other means of establishing a communications link between the computer systems may be used. It should also be appreciated that the application module could equivalently be implemented on host or server computer systems other than general computer systems, and could equivalently be transmitted to the host computer system by means other than a CD-ROM, for example, by way of the network connection interface 560.

Furthermore, a number of program modules may be stored in the drives and RAM 512 of the general computer system 502. Program modules control how the general computer system 502 functions and interacts with the user, with I/O devices or with other computers. Program modules include routines, operating systems 564, target application program modules 566, data structures, browsers, and other software or firmware components. The method of the present invention may be included in an application module and the application module may conveniently be implemented in one or more program modules based upon the methods described herein. The target application program modules 566 may comprise a variety of applications used in conjunction with the present invention.

It should be appreciated that no particular programming language is described for carrying out the various procedures described in the detailed description because it is considered that the operations, steps, and procedures described and illustrated in the accompanying drawings are sufficiently disclosed to permit one of ordinary skill in the art to practice an exemplary embodiment of the present invention. Moreover, there are many computers and operating systems that may be used in practicing an exemplary embodiment, and therefore no detailed computer program could be provided which would be applicable to all of these many different systems. Each user of a particular computer will be aware of the language and tools which are most useful for that user's needs and purposes.

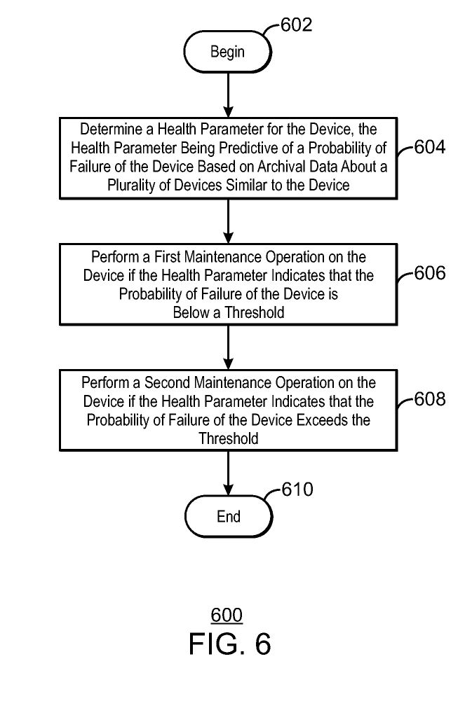

FIG. 6 is a process flow diagram showing a method of determining a maintenance operation for a device in accordance with an exemplary embodiment of the present invention. The method is generally referred to by the reference number 600. At block 602, the method begins.

At block 604, a health parameter for the device is determined. According to an exemplary embodiment of the present invention, the health parameter is predictive of a probability of failure of the device based on archival data about a plurality of devices similar to the device. As shown at block 606, a first maintenance operation is performed on the device if the health parameter indicates that the probability of failure of the device is below a threshold. As set forth herein, the health parameter may be determined by a transfer function that is created based on one or more types of health data relating to failure modes of the device. At block 608, a second maintenance operation is performed on the device if the health parameter indicates that the probability of failure of the device exceeds the threshold. The method ends, as shown at block 610.

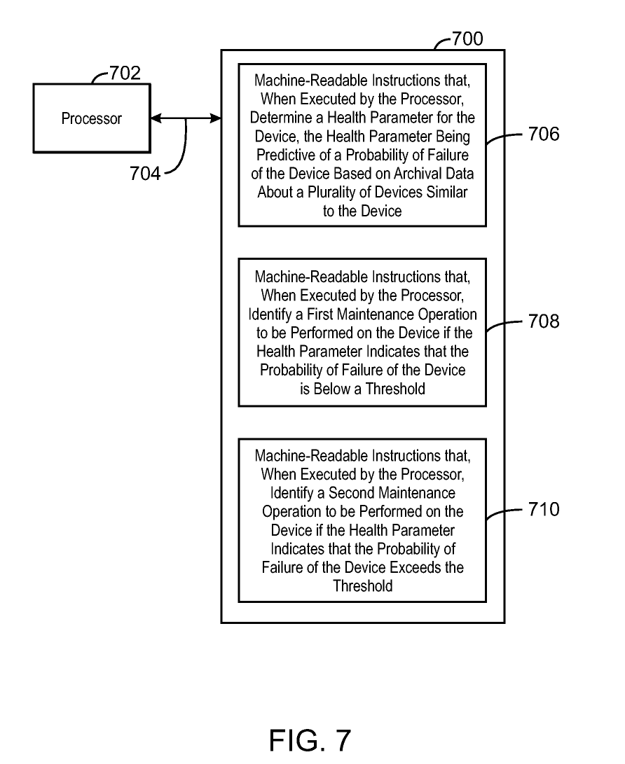

FIG. 7 is a block diagram of a tangible, machine-readable medium that stores code adapted to determine a maintenance operation according to an exemplary embodiment of the present invention. The tangible, machine-readable medium is generally referred to by the reference number 700.

The tangible, machine-readable medium 700 may correspond to any typical storage device that stores computer-implemented instructions, such as programming code or the like. For example, the medium may comprise one or more of the storage devices described herein with reference to FIG. 5.

When read and executed by a processor 702 via a communication path 704, the instructions stored on the tangible, machine-readable medium 700 are adapted to cause the processor 702 to select a maintenance operation according to an exemplary embodiment of the present invention, as described herein.

A region 706 of the tangible, machine-readable medium 700 stores machine-readable instructions that, when executed by the processor 702, determine a health parameter for the device. As described herein, the health parameter being predictive of a probability of failure of the device based on archival data about a plurality of devices similar to the device.

A region 708 of the tangible, machine-readable medium 700 stores machine-readable instructions that, when executed by the processor 702, identify a first maintenance operation to be performed on the device if the health parameter indicates that the probability of failure of the device is below a threshold. A region 710 of the tangible, machine-readable medium 700 stores machine-readable instructions that, when executed by the processor 702, identify a second maintenance operation to be performed on the device if the health parameter indicates that the probability of failure of the device exceeds the threshold.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method of selecting a maintenance operation to be performed on a device, the method comprising:
determining a health parameter for the device, the health parameter being predictive of a probability of failure of the device based on archival data about a plurality of devices similar to the device;
performing a first maintenance operation on the device if the health parameter indicates that the probability of failure of the device is below a threshold; and
performing a second maintenance operation on the device if the health parameter indicates that the probability of failure of the device exceeds the threshold.

2. The method recited in claim 1, wherein the archival data comprises engine health data.

3. The method recited in claim 2, wherein the engine health data comprises oil parameter data, fault log data, or parts usage data.

4. The method recited in claim 2, wherein the engine health data comprises oil parameter data, the oil parameter data relating to a viscosity, an alkalinity, an acidity, an amount of soot, oxidation, sulfation, nitration or a metal content.

5. The method recited in claim 1, wherein the health parameter is determined by a transfer function.

6. The method recited in claim 5, wherein the transfer function embodies information regarding to a magnitude of health data representative of a characteristic of the device and a slope of the health data representative of the characteristic of the device.

7. The method recited in claim 5, wherein the transfer function embodies a regression analysis, an area under a curve analysis or a time fulfillment analysis.

8. The method recited in claim 1, wherein the health parameter may predict potential failure of the device even though underlying health data on which the health parameter is based does not exceed an acceptable limit at a particular time.

9. The method recited in claim 1, wherein the first maintenance operation comprises a top deck maintenance process.

10. The method recited in claim 1, wherein the second maintenance operation comprises a complete overhaul.

11. The method recited in claim 1, wherein the device comprises a locomotive engine.

12. The method recited in claim 1, wherein the second maintenance operation comprises the first maintenance operation.

13. The method recited in claim 1, wherein the health parameter is adapted to indicate a potential problem with the device even though the health parameter indicates that the probability of failure of the device is below the threshold.

14. A computer system that is adapted to determine a maintenance operation to be performed on a device, the computer system comprising:
a processor; and
a tangible, machine-readable storage medium that stores machine-readable instructions for execution by the processor, the machine-readable instructions comprising:
code that, when executed by the processor, is adapted to cause the processor to determine a health parameter for the device, the health parameter being predictive of a probability of failure of the device based on archival data about a plurality of devices similar to the device;
code that, when executed by the processor, is adapted to cause the processor to identify a first maintenance operation to be performed on the device if the health parameter indicates that the probability of failure of the device is below a threshold; and
code that, when executed by the processor, is adapted to cause the processor to identify a second maintenance operation to be performed on the device if the health parameter indicates that the probability of failure of the device exceeds the threshold.

15. The computer system recited in claim 14, wherein the archival data comprises engine health data.

16. The computer system recited in claim 15, wherein the engine health data comprises oil parameter data, fault log data, or parts usage data.

17. The computer system recited in claim 14, wherein the engine health data comprises oil parameter data, the oil parameter data relating to a viscosity, an alkalinity, an acidity, an amount of soot, oxidation, sulfation, nitration or a metal content.

18. The computer system recited in claim 14, wherein the health parameter is determined by a transfer function.

19. The computer system recited in claim 18, wherein the transfer function embodies information regarding to a magnitude of health data representative of a characteristic of the device and a slope of the health data representative of the characteristic of the device.

20. The computer system recited in claim 18, wherein the transfer function embodies a regression analysis, an area under a curve analysis or a time fulfillment analysis.

21. The computer system recited in claim 14, wherein the health parameter may predict potential failure of the device even though underlying health data on which the health parameter is based does not exceed an acceptable limit at a particular time.

22. The computer system recited in claim 14, wherein the first maintenance operation comprises a top deck maintenance process.

23. The computer system recited in claim 14, wherein the second maintenance operation comprises a complete overhaul.

24. The computer system recited in claim 14, wherein the device comprises a locomotive engine.

25. The computer system recited in claim 14, wherein the second maintenance operation comprises the first maintenance operation.

26. The computer system recited in claim 14, wherein the health parameter is adapted to indicate a potential problem with the device even though the health parameter indicates that the probability of failure of the device is below the threshold.

27. A tangible, machine-readable medium that stores machine-readable instructions executable by a processor to select a maintenance operation to be performed on a device, the tangible-machine-readable medium comprising:
machine-readable instructions that, when executed by the processor, determine a health parameter for the device, the health parameter being predictive of a probability of failure of the device based on archival data about a plurality of devices similar to the device;
machine-readable instructions that, when executed by the processor, identify a first maintenance operation to be performed on the device if the health parameter indicates that the probability of failure of the device is below a threshold; and
machine-readable instructions that, when executed by the processor, identify a second maintenance operation to be performed on the device if the health parameter indicates that the probability of failure of the device exceeds the threshold.
